(19) United States
(12) Patent Application Publication
(10) Pub. No.: US 2024/0237575 A1
(43) Pub. Date: Jul. 18, 2024

(54) LAWN MOWERS HAVING AUTOSENSING MODULES

(71) Applicant: CANADIAN TIRE CORPORATION, LIMITED, Toronto (CA)

(72) Inventors: Samuel CHENG, Toronto (CA); Tomasz PIOTROWSKI, Oshawa (CA); Abdul Haleem Ahamed KOYA, Oakville (CA)

(21) Appl. No.: 18/690,471

(22) PCT Filed: Sep. 14, 2022
(86) PCT No.: PCT/CA2022/051367

§ 371 Date: Mar. 8, 2024

Related U.S. Application Data
(60) Provisional application No. 63/244,515, filed on Sep. 15, 2021.

(51) Int. Cl. A01D 34/82; A01D 101/00

(52) U.S. Cl. CPC A01D 34/828; A01D 2101/00

(57) ABSTRACT

Described are lawn mowers/autosensing modules for lawn mowers configured to engage and/or disengage a drive motor based on one or more of: a tilt angle relative to a direction of travel, rotations of at least one wheel, applied load, a tension and a lawn mower position. The lawn mowers may comprise: a cutting blade(s); a blade motor operatively connected to the cutting blade(s); a drive motor operatively connected to a wheel assembly; a tilt sensor configured to sense a tilt angle of the lawn mower; and a controller operatively connected to the drive motor and in communication with the tilt sensor, and configured to disengage the drive motor in response to receiving a disengage signal, without disengaging the blade motor. When the tilt sensor senses the tilt angle is at or above a disengage angle, the tilt sensor transmits the disengage signal for receipt by the controller.

### CROSS-REFERENCE TO RELATED APPLICATIONS

The present application claims priority from U.S. Provisional Patent Application No. 63/244,515 filed on Sep. 15, 2021, the contents being incorporated herein by reference.

### FIELD

The specification relates generally to lawn mowers, and specifically to self-propelled lawn mowers having autosensing modules.

### BACKGROUND

Typically, self-propelled lawn mowers require the user to release the cutting blade or otherwise cut power to the blade to stop the wheels from spinning each time the lawn mower is to be turned on a cutting surface. This can be a nuisance and, more importantly, a safety hazard for the user.

### SUMMARY

According to some embodiments, there is provided a lawn mower comprising: at least one cutting blade; a blade motor operatively connected to the at least one cutting blade via a blade drive assembly; a drive motor operatively connected to a wheel assembly of the lawn mower; a tilt sensor configured to sense a tilt angle of the lawn mower relative to a direction of travel along a cutting surface; and a controller operatively connected to the drive motor and in communication with the tilt sensor, the controller configured to disengage the drive motor in response to receiving a disengage signal, without disengaging the blade motor; wherein when the tilt sensor senses the tilt angle is at or above a disengage angle, the tilt sensor transmits the disengage signal for receipt by the controller.

According to some embodiments, the controller is further configured to engage the drive motor in response to receiving an engage signal. According to some embodiments, when the tilt sensor senses that the tilt angle is at an engage angle less than the disengage angle relative to the direction of travel along the cutting surface, the tilt sensor transmits the engage signal for receipt by the controller.

According to some embodiments, the lawn mower further comprises: a wheel rotation sensor in communication with the controller and configured to sense rotation of at least one wheel of the wheel assembly, wherein when the sensed rotation is at or below a disengage number of rotations per minute (RPM), the wheel rotation sensor transmits the disengage signal for receipt by the controller. According to some embodiments, when the sensed rotation is at or above an engage number of rotations per minute (RPM), the wheel rotation sensor is configured to transmit the engage signal for receipt by the controller.

According to some embodiments, the lawn mower further comprises one or more of: a wheel load sensor configured to sense a load applied to at least one wheel of the lawn mower via the cutting surface, the wheel load sensor being in communication with the controller and configured to transmit the disengage signal for receipt by the controller when the sensed load is at or below a disengage load; a tension sensor operatively connected to at least one wheel tension rod and in communication with the controller, the tension sensor configured to sense a tensile load on the at least one wheel tension rod and to transmit the disengage signal for receipt by the controller when the sensed tensile load is at or below a disengage tensile load; and a position sensor configured to sense a position of the lawn mower relative to the cutting surface, the position sensor being in communication with the controller and configured to transmit the disengage signal when the sensed position is at or above a disengage distance away from the cutting surface.

According to some embodiments, the tilt sensor comprises one or more of an accelerometer, an inclinometer and a gyroscope.

According to some embodiments, the disengage angle is in a range of about 1 degree to about 90 degrees, or about 30 degrees to about 45 degrees.

According to some embodiments, the lawn mower further comprises: an input device in communication with the tilt sensor and configured to receive input data indicative of a selected disengage angle and to transmit the received input data to the tilt sensor, wherein the disengage angle is the selected disengage angle.

According to some embodiments, there is also provided a lawn mower comprising: at least one cutting blade; a blade motor operatively connected to the at least one cutting blade via a blade drive assembly; a drive motor operatively connected to a wheel assembly of the lawn mower; a wheel rotation sensor configured to sense rotation of at least one wheel of the wheel assembly; and a controller operatively connected to the drive motor and in communication with the wheel rotation sensor, the controller configured to disengage the drive motor in response to receiving a disengage signal without disengaging the blade motor; wherein when the sensed rotation is at or below a disengage number of rotations per minute (RPM), the wheel rotation sensor transmits the disengage signal for receipt by the controller.

According to some embodiments, the controller is further configured to engage the drive motor in response to receiving an engage signal. According to some embodiments, the wheel rotation sensor is configured to transmit the engage signal for receipt by the controller when the sensed rotation is at or above an engage number of rotations per minute (RPM).

According to some embodiments, the lawn mower further comprises an input device in communication with the wheel rotation sensor and configured to: receive input data indicative of a selected disengage number of rotations per minute and to transmit the received input data to the wheel rotation sensor, wherein the disengage number of rotations per minute is the selected disengage number of rotations; and/or receive input data indicative of a selected engage number of rotations per minute and to transmit the received input data to the wheel rotation sensor, wherein the engage number of rotations per minute is the selected engage number of rotations per minute.

According to some embodiments, the lawn mower further comprises: a tilt sensor in communication with the controller and configured to sense a tilt angle of the lawn mower relative to a direction of travel along a cutting surface; wherein when the tilt sensor senses the tilt angle is at or above a disengage angle, the tilt sensor transmits the disengage signal for receipt by the controller. According to some embodiments, the tilt sensor comprises one or more of an accelerometer, an inclinometer and a gyroscope. According to some embodiments, the disengage angle is in a range of about 1 degree to about 90 degrees, or about 30 degrees to about 45 degrees.

According to some embodiments, the input device is further configured to receive input data indicative of a selected disengage angle and to transmit the received input data to the tilt sensor, wherein the disengage angle is the selected disengage angle. According to some embodiments, when the tilt sensor senses that the tilt angle is at an engage angle less than the disengage angle relative to the direction of travel along the cutting surface, the tilt sensor transmits the engage signal for receipt by the controller.

According to some embodiments, the lawn mower further comprises one or more of: a wheel load sensor configured to sense a load applied to at least one wheel of the lawn mower via the cutting surface, the wheel load sensor being in communication with the controller and configured to transmit the disengage signal for receipt by the controller when the sensed load is at or below a disengage load; a tension sensor operatively connected to at least one wheel tension rod and in communication with the controller, the tension sensor configured to sense a tensile load on the at least one wheel tension rod and to transmit the disengage signal for receipt by the controller when the sensed tensile load is at or below a disengage tensile load; and a position sensor configured to sense a position of the lawn mower relative to the cutting surface, the position sensor being in communication with the controller and configured to transmit the disengage signal when the sensed position is at or above a disengage distance away from the cutting surface.

According to some embodiments, there is also provided a lawn mower comprising: at least one cutting blade; a blade motor operatively connected to the at least one cutting blade via a blade drive assembly; a drive motor operatively connected to a wheel assembly of the lawn mower; a position sensor configured to sense a position of the lawn mower relative to the cutting surface; and a controller operatively connected to the drive motor and in communication with the tilt sensor, the controller configured to disengage the drive motor in response to receiving a disengage signal, without disengaging the blade motor; wherein when the position sensor being in communication with the controller and configured to transmit the disengage signal when the sensed position is at or above a disengage distance away from the cutting surface.

According to some embodiments, there is also provided an autosensing module for a lawn mower comprising: a drive motor configured to operatively connect to a wheel assembly of the lawn mower; one or more of a tilt sensor configured to sense a tilt angle of the lawn mower relative to a direction of travel along a cutting surface, a wheel rotation sensor configured to sense rotation of at least one wheel of the wheel assembly, a wheel load sensor configured to sense a load applied to at least one wheel of the lawn mower via the cutting surface, a tension sensor operatively connected to at least one wheel tension rod, and a position sensor configured to sense a position of the lawn mower relative to the cutting surface; a controller operatively connected to the drive motor and configured to disengage the drive motor in response to receiving a disengage signal, without disengaging a motor operatively connected to at least one blade of the lawn mower; wherein the tilt sensor, the wheel rotation sensor, the wheel load sensor, the tension sensor and the position sensor are in communication with the controller and configured to generate and transmit the disengage signal for receipt by the controller when: the tilt angle sensed by the tilt sensor is at or above a disengage angle, or the sensed rotation is at or below a disengage number of rotations per minute (RPM), or the sensed load is at or below a disengage load, or the sensed tensile load is at or below a disengage tensile load, or the sensed position is at or above a disengage distance away from the cutting surface.

According to some embodiments, the lawn mower of any one of the preceding embodiments is a self-propelled lawn mower.

### BRIEF DESCRIPTIONS OF THE DRAWINGS

For a better understanding of the various embodiments described herein and to show more clearly how they may be carried into effect, reference will now be made, by way of example only, to the accompanying drawings in which:

FIG. 1 depicts a schematic of a lawn mower, according to non-limiting embodiments;

FIGS. 2A to 2D depict diagrams of a lawn mower in various positions and orientations, according to non-limiting embodiments;

FIG. 3 depicts an enlarged view of a front wheel assembly of a lawn mower having a wheel rotation sensor, according to non-limiting embodiments;

FIG. 4 depicts an enlarged view of a front wheel of the assembly depicted in FIG. 3, according to non-limiting embodiments;

FIGS. 5A to 5D depict views of a lawn mower, according to non-limiting embodiments;

FIG. 6 depicts a diagram of a lawn mower, according to non-limiting embodiments;

FIG. 7 depicts a perspective view of a lawn mower, according to non-limiting embodiments; and

FIG. 8 depicts a schematic of an autosensing module for a lawn mower, according to non-limiting embodiments.

### DETAILED DESCRIPTION

Herein described are self-propelled lawn mowers and/or autosensing modules for lawn mowers in which, at least according to some embodiments, the self-propel drive system can be operated independently from the system driving the cutting blade. As described herein, the lawn mowers may comprise separate motors for propelling the cutting blade and for operating the self-propel system. For example, according to some embodiments, the motor driving the self-propel system is disengaged, without disengaging the motor driving the cutting blade(s), when the lawn mower is tilted to certain angle relative to a cutting direction of the lawn mower along the cutting surface (such as, a grass lawn), such as to affect a turn of the lawn mower. According to some embodiments, the motor driving the self-propel system is disengaged when the sensed number of rotations per minute (RPM) fall below a certain number. As will become apparent, the described lawn mowers and autosensing modules for lawn mowers typically help avoid the need to release the cutting blade to safely turn the lawn mower on the cutting surface.

It will be appreciated that for simplicity and clarity of illustration, where considered appropriate, reference numerals may be repeated among the figures to indicate corresponding or analogous elements. In addition, numerous specific details are set forth in order to provide a thorough understanding of the exemplary aspects of the present application described herein. However, it will be understood by those of ordinary skill in the art that the exemplary aspects described herein may be practiced without these specific details. In other instances, well-known methods, procedures and components have not been described in detail so as not to obscure the exemplary aspects described herein. Also, the description is not to be considered as limiting the scope of the exemplary aspects described herein. Any systems, method steps, method blocks, components, parts of components, and the like described herein in the singular are to be interpreted as also including a description of such systems, method steps or tasks, components, parts of components, and the like in the plural, and vice versa.

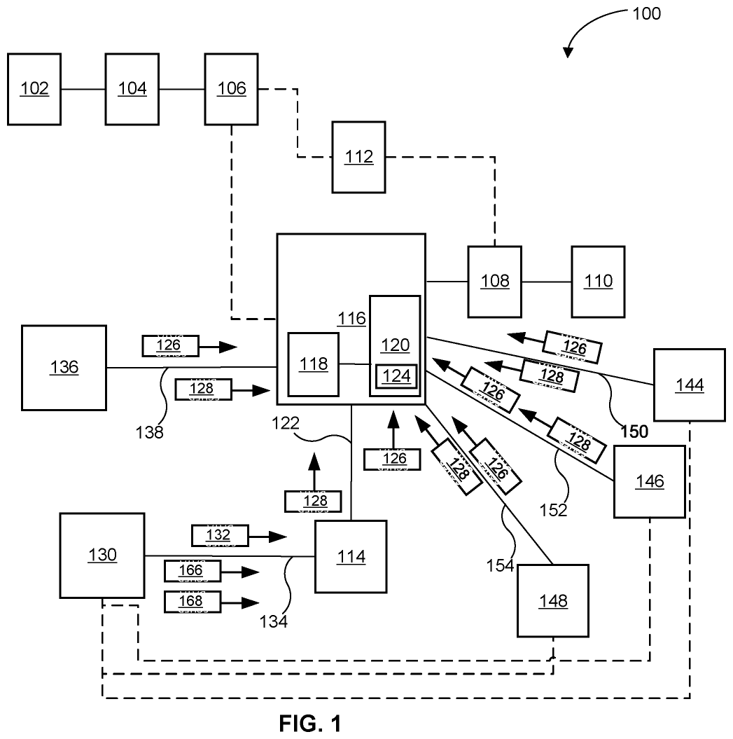

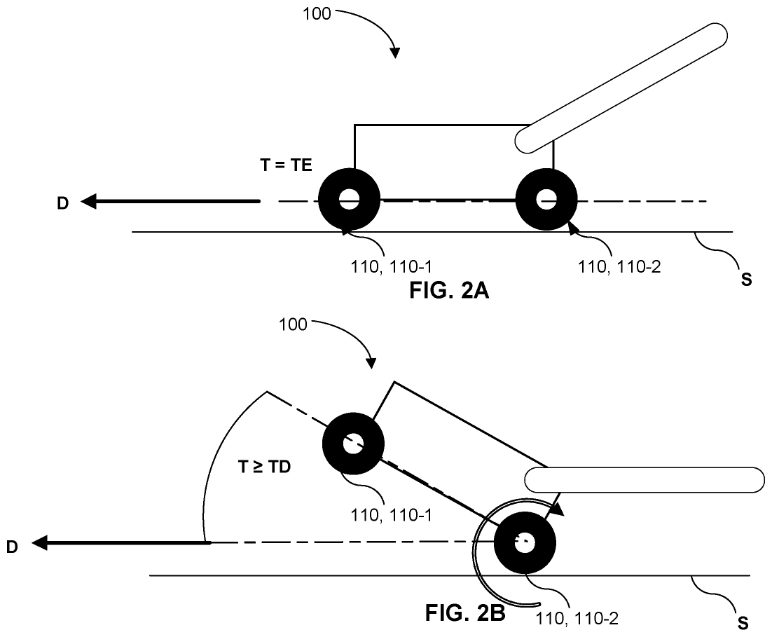

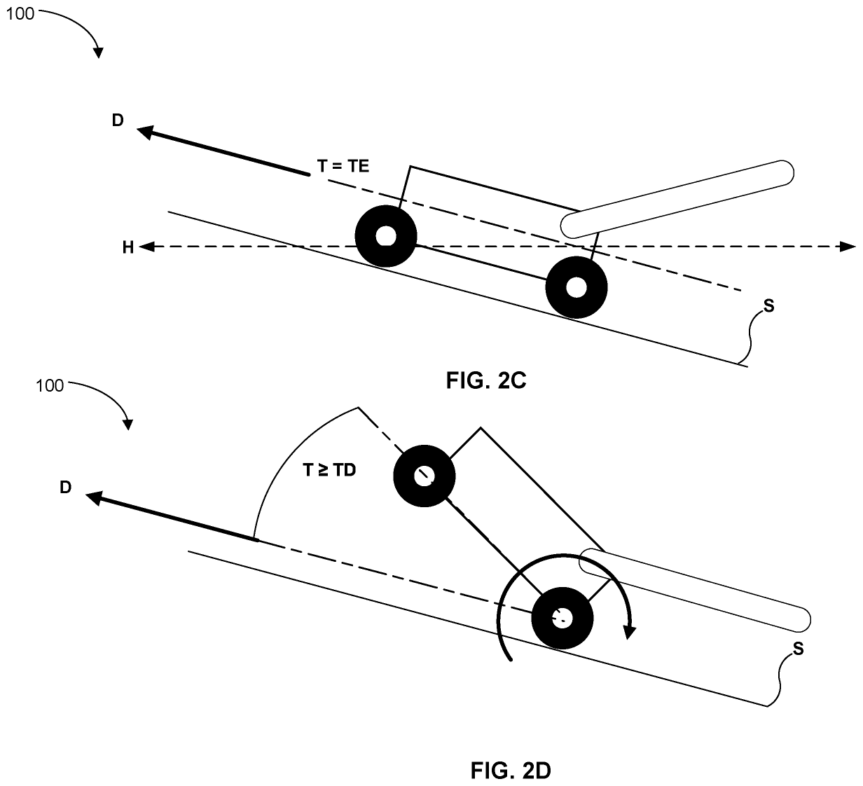

Attention is directed to FIG. 1 which depicts a schematic of a lawn mower 100, according to non-limiting embodiments. Lawn mower 100 comprises at least one cutting blade, such as blade(s) 102, and a blade motor 106 operatively connected to blade(s) 102 via a blade drive assembly 104. Lawn mower 100 further comprises a drive motor 108 operatively connected to a wheel assembly 110 of lawn mower 100 (which may comprise front wheel assembly 110-1 and rear wheel assembly 110-2 as depicted in, for example, FIGS. 2A and 2B). According to some embodiments, lawn mower 100 is rear wheel driven such that drive motor 108 is operatively connected to rear wheel assembly 110-2. Blade motor 106 and drive motor 108 are each configured to be operatively connected to at least one power supply, such as power supply 112. According to some embodiments, power supply 112 comprises a plurality of power supplies. For example, according to some embodiments, the power supply operatively connected to the blade motor 106 is separate from the power supply operatively connected to the drive motor 108. Any suitable power supply or combination of suitable power supplies are contemplated for power supply 112, such as a battery or a plurality of batteries. According to some embodiments, the battery or batteries are rechargeable.

According to some embodiments, lawn mower 100 comprises at least one tilt sensor, such as tilt sensor 114, configured to sense a tilt angle, T, of the lawn mower relative to a direction of travel, D, along a cutting surface, S, such as a grass lawn (see FIGS. 2A and 2B). Tilt sensor 114 comprises any device or combination of devices suitable for determining the angular position of lawn mower 100 relative to direction of travel D. For example, according to some embodiments, the tilt sensor comprises one or more of an accelerometer, an inclinometer and a gyroscope. Any suitable device or combination of devices for sensing changes in the angular position of lawn mower 100 is contemplated. For example, according to some embodiments, the tilt sensor comprises an Adafruit™ MMA8451 accelerometer. According to some embodiments, the tilt sensor comprises an electrolytic tilt sensor.

Lawn mower 100 comprises at least one controller, such as controller 116. According to some embodiments, controller 116 is a microcontroller. Controller 116 may comprise processing device(s) 118 coupled to memory 120, enabled to control at least some operations of lawn mower 100. Controller 116 is operatively connected to drive motor 108 and in communication with tilt sensor 114 via one or more communication links, such as link 122. Link 122 comprises any suitable wired and/or wireless communication link(s), or suitable combination thereof, and configured to operated in accordance with any suitable wired and/or wireless protocols. As used herein, the terms “processing device”, “processing devices”, “processing device(s)”, “processor”, “processors” or “processor(s)” may refer to any combination of processing devices, and the like, suitable for carrying out the actions or methods described herein. For example, processing device(s) 118 may comprise any suitable processing device, or combination of processing devices, including but not limited to a microprocessor, a central processing unit (CPU) and the like. Other suitable processing devices are within the scope of the application. Likewise, memory 120 can comprise any suitable memory device, including but not limited to any suitable one of, or combination of, a local and/or remote volatile memory, non-volatile memory, random access memory (RAM), read-only memory (ROM), hard drive, optical drive, buffer(s), cache(s), flash memory, magnetic computer storage devices (e.g. hard disks, floppy disks, and magnetic tape), optical memory ((e.g., CD(s) and DVD(s)), and the like. Other suitable memory devices are within the scope of the application. As such, it is understood that the term “memory”, or any variation thereof, as used herein may comprise a tangible and non-transitory computer-readable medium (i.e., a medium which does not comprise only a transitory propagating signal per se) comprising or storing computer-executable instructions, such as computer programs, sets of instructions, code, software, and/or data for execution of any method(s), step(s) or process(es) described herein by any processing device(s) and/or microcontroller(s) described herein. Memory 120 comprises or is enabled to store computer-executable instructions, such as instructions 124, for execution by at least one processing device, including processing device 118.

Controller 116 is configured to disengage drive motor 108 in response to receiving a disengage signal, such as disengage signal 126, without disengaging blade motor 106. As such, rotation of at least one of the wheels of wheel assembly 110 may be slowed to a rate that allows a user to turn lawn mower 100 without having to disengage or otherwise release blade 106.

According to some embodiments, controller 116 is not operatively connected to blade 106 and blade motor 106 is controlled by a device or combination of devices separate from controller 116. According to some embodiments, controller 116 is also operatively connected to blade motor 106 and drive motor 108 and is configured to selectively engage and/or disengage blade motor 106 and/or drive motor 108.

As noted above, controller 116 is configured to disengage drive motor 108 in response to receiving disengage signal 126. According to some embodiments, when tilt sensor 114 senses or otherwise determines that the tilt angle T is at or above a disengage angle, such as TD, tilt sensor 114 is configured to generate and transmit disengage signal 126 for receipt by controller 116. As discussed, when turning a lawn mower, particularly if a sharp turn is desired, a user usually tilts the lawn mower rearward such that at least a portion of the load bearing on the front wheel assembly during a typical cutting pass is shifted onto the rear wheel assembly. If power to the rear wheels is not cut, then turning a lawn mower having a driven wheel assembly (such as a self-propelled lawn mower) can be quite difficult and, in some situations, can be quite dangerous. Having controller 116 automatically cut power to the motor driving the wheel assembly, such as by cutting power to drive motor 108, in response to tilting the lawn mower when it is at or above a certain angle may allow a user to make a safer and/or sharper turn.

As shown in FIGS. 2A to 2D, the tilt angle is relative to the direction of travel D, and not to the horizonal, H. Since cutting surface S may include at least one portion that is on an incline to the horizontal H (positive and/or negative incline to the horizontal), basing the tilt angle on the vector direction of travel instead of the horizontal H may help avoid inadvertent disengagement of the drive motor 108 when the lawn mower travels along a cutting surface that is uneven or otherwise not level with the horizontal H.

According to some embodiments, the disengage angle TD is about 45 degrees. According to some embodiments, the disengage angle TD is about 30 degrees. According to some embodiments, the disengage angle TD is in a range of about 30 degrees to about 45 degrees. According to some embodiments, the disengage angle is in a range of about 1 degree to about 90 degrees.

According to some embodiments, controller 116 is further configured to engage drive motor 108 in response to receiving an engage signal, such as engage signal 128 (FIG. 1). For example, according to some embodiments, when tilt sensor 114 senses or otherwise determines that the tilt angle T of the lawn mower is at an engage angle, TE, that is less than the disengage angle TD relative to the direction of travel D along the cutting surface S, tilt sensor 114 is further configured to generate and transmit engage signal 128 for receipt by controller 116.

According to some embodiments, the disengage angle TD is user-selectable. For example, lawn mower 100 may further comprise or be configured to communicate with a suitable input device. According to some embodiments, lawn mower 100 comprises input device 130 configured to communicate with tilt sensor 114, such as via communication link(s) 134, and to receive input data indicative of a selected disengage angle, such as input data 132. Input device 130 comprises any suitable computing device or combination of computing devices. Input device 130 is generally configured to receive input data and can comprise any suitable combination of input devices, including but not limited to a keyboard, a keypad, a pointing device, a mouse, a track wheel, a trackball, a touchpad, a touch screen and the like. Other suitable input devices are within the scope of this specification. According to some embodiments, the input device comprises a display which may show, for example, the selected disengage angle and/or other information.

According to some embodiments, the described lawn mowers and lawn mower modules comprise one or more sensors in addition to, or in place of, tilt sensor 114 that are configured to transmit a disengage signal to controller 1116 based on parameters or conditions other than the tilt angle. For example, the Applicant found that when rear-wheel driven lawn mowers are tilted to make a turn, lifting the front wheels off the cutting surface, the rotational rate of the front wheels drops (due to friction, for example). With this in mind, according to some embodiments, lawn mower 100 comprises at least one wheel rotation sensor in addition to or in place of tilt sensor 114, such as wheel rotation sensor 136 configured to communicate with controller 116 via communication link(s) 138 and to sense rotation of at least one wheel of wheel assembly 110 (FIGS. 1, 3 and 4). When the sensed rotation of at least one wheel, such as of a wheel of front wheel assembly 110-1, is determined to be at or below a disengage number of rotations per minute (RPM), the wheel rotation sensor is configured to generate and transmit disengage signal 126 for receipt by controller 116.

According to some embodiments, the described lawn mowers and lawn mower modules comprise an input device, such as input device 130 or an input device that is similarly configured, configured to communicate with at least one wheel rotation sensor, such as wheel rotation sensor 136. The input device is configured to: receive input data indicative of a selected disengage number of rotations per minute and to transmit the received input data to the wheel rotation sensor, wherein the disengage number of rotations per minute is the selected disengage number of rotations (for which the wheel rotation sensor is configured to transmit disengage signal 126 for receipt by controller 116 as discussed above); and/or receive input data indicative of a selected engage number of rotations per minute and to transmit the received input data to the wheel rotation sensor, wherein the engage number of rotations per minute is the selected engage number of rotations per minute (for which the wheel rotation sensor is configured to transmit engage signal 128 for receipt by controller 116 as discussed above). For example, input device 130 may be configured to communicate with wheel rotation sensor 136, such as via communication link(s) 134, and to receive input data indicative of a selected disengage number of rotations per minute, such as input data 166, and to transmit the received input data to wheel rotation sensor 136, wherein the disengage number of rotations per minute is the selected disengage number of rotations. Input device 130 may also be configured to receive input data indicative of a selected engage number of rotations per minute, such as input data 168, and to transmit the received input data to wheel rotation sensor 136, wherein the engage number of rotations per minute is the selected engage number of rotations per minute.

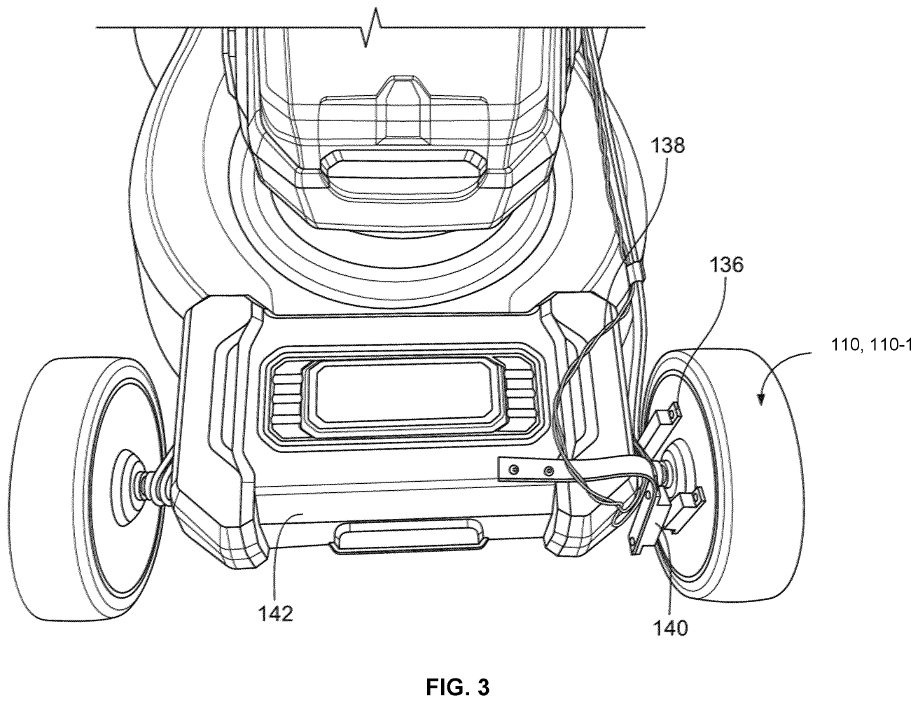

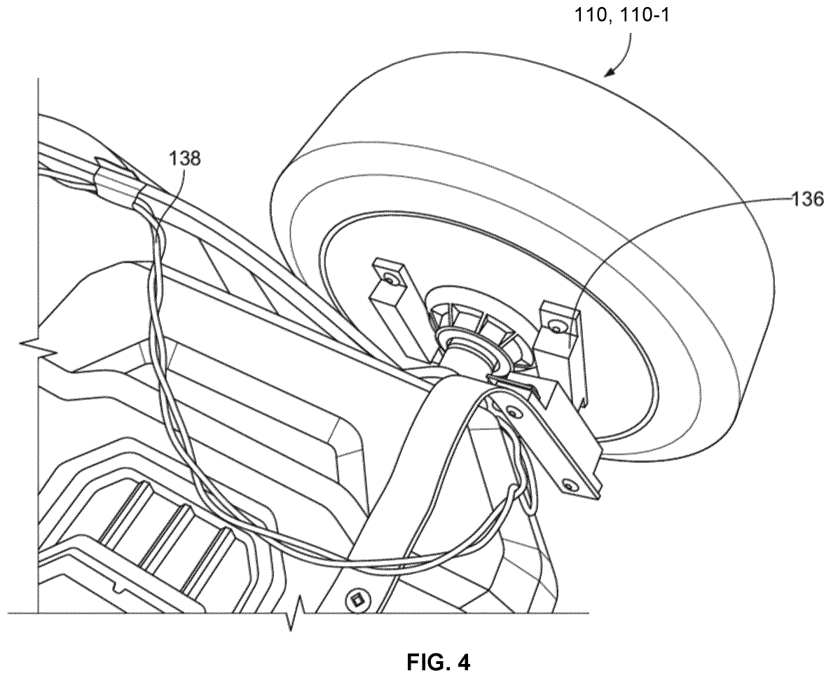

Any suitable sensor or combination of sensors are contemplated. For example, according to some embodiments, the wheel rotation sensor comprises a reed switch adapted to couple to at least one wheel, such as one wheel of front wheel assembly 100-1, and configured sense changes in a sensed magnetic field generated by magnet 140, coupled to lawn mower housing 142 (FIGS. 3 and 4), as the wheel rotates relative to the housing 142. As the wheel rotates, the magnet passes the reed switch, which registers a “high” signal on the pin, which is sent to the microcontroller to track the RPM. When the RPM drops below a certain threshold, the disengage number of rotations per minute, the reed switch generates and transmits the disengage signal to the controller. According to some embodiments, wheel rotation sensor 136 is configured to generate and transmit an engage signal, such as engage signal 128, for receipt by controller 116 when the sensed rotation is below an engage number of RPM.

Additional sensors are contemplated. For example, according to some embodiments, lawn mower 100 comprises one or more of the following sensors in addition to or in place of the wheel rotation sensor(s) and/or tilt sensor(s) described above: at least one wheel load sensor, such as wheel load sensor 144; at least one tension sensor, such as tension sensor 146; and, at least one position sensor, such as position sensor 148.

The wheel load sensor(s) are in communication with the controller and configured to sense a load applied to at least one wheel of the lawn mower via the cutting surface. For example, according to some embodiments, wheel load sensor 144 is in communication with controller 116 via communication link(s) 150. The wheel tension load sensor(s) are further configured to generate and transmit the disengage signal 126 to the controller when the sensed load is at or below a disengage tensile load. According to some embodiments, the wheel tension load sensor(s) are further configured to generate and transmit the engage signal 128 when the sensed load is above an engage load.

The tension load sensor(s) are operatively connected to at least one wheel tension rod, such as tension sensor 146 operatively connected to tension rod 158 coupled to front wheel axle 160 and/or rear wheel axle 162 shown in FIG. 7, and in communication with the controller (via, for example, communication link(s) 152). The tension load sensor(s) are further configured to sense a tensile load on the tension rod(s) at or below a disengage tensile load, such as when the front wheels are lifted off the cutting surface, and to generate and transmit the disengage signal for receipt by controller 116. According to some embodiments, the tension load sensor(s) are further configured to generate and transmit the engage signal when the sensed tensile load is above an engage tensile load, such as when the front wheels are placed on the cutting surface.

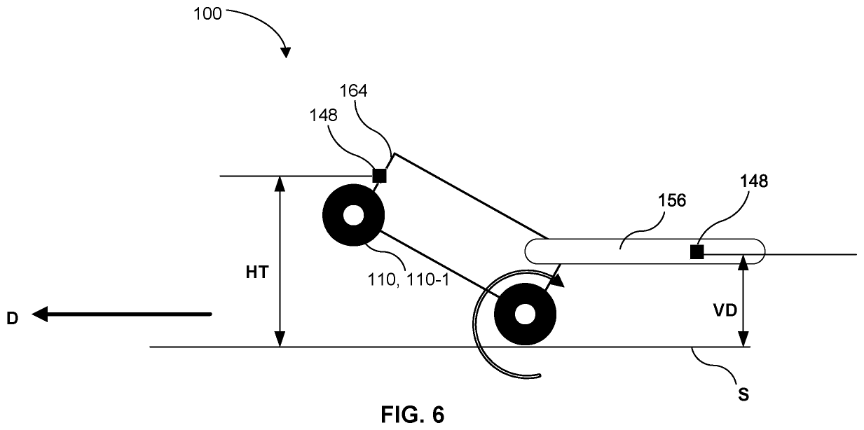

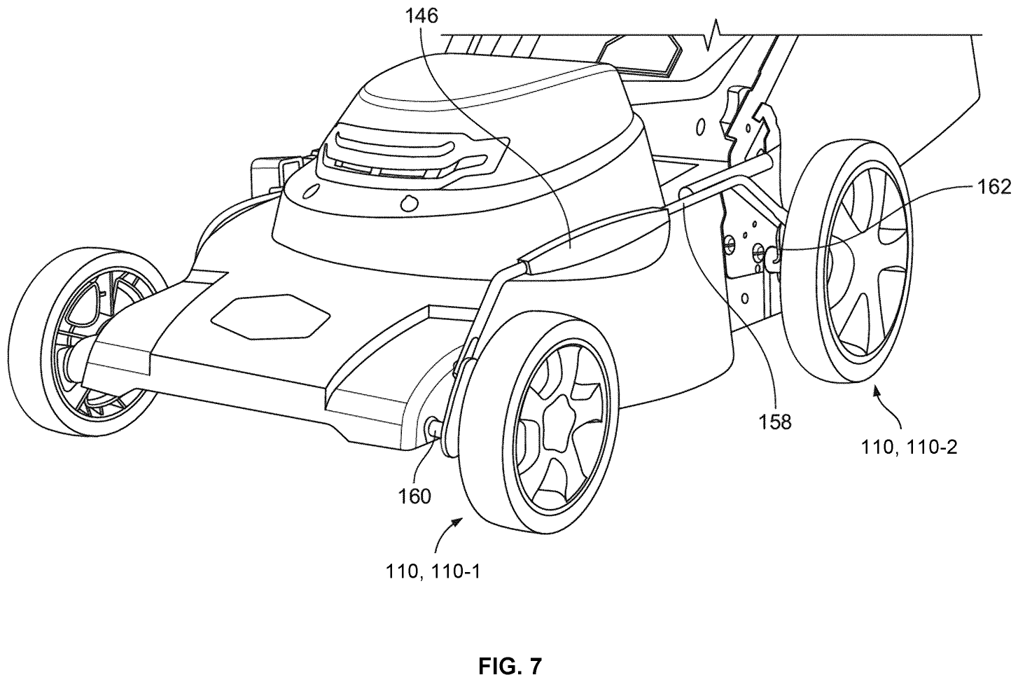

The position sensor is configured to sense a position of the lawn mower relative to the cutting surface. The position sensor is in communication with the controller and is configured to generate and transmit the disengage signal for receipt by the controller when the sensed position, such as sensed position HT (FIG. 6), is at or above a disengage distance away from the cutting surface. For example, according to some embodiments, position sensor 148, in communication with controller 116 via communication link(s) 154, is configured to generate and transmit disengage signal 126 for receipt by controller 116. According to some embodiments, the position sensor(s) are further configured to generate and transmit the engage signal when the sensed position is above an engage tensile load. According to some embodiments, the position sensor comprises one or more sensors. For example, according to some embodiments, position sensor 148 comprises a vertical distance sensor located on the bumper or housing of the lawn mower 100 and/or a vertical distance sensor mounted to a handle bar, such as handle bar 156, configured to determine the vertical distance, VD, of the lawn mower in respect of the cutting surface S.

Any suitable location(s) for the position sensor(s) on lawn mower 100 is contemplated. For example, according to some embodiments, position senor 148 is coupled to front bumper 164 and/or handle 156. According to some embodiments, position sensor(s) 148 continuously and/or frequently monitors the sensed vertical distance VD and/or sensed position HT. According to some embodiments, the disengage distance is about 10 cm.

According to some embodiments, various parameters are user-selectable, such as the disengage number of rotations per minute, the disengage load, the disengage tensile load and/or the disengage distance. For example, according to some embodiments, input device 130 is in communication with one or more of a wheel rotation sensor 136, a wheel load sensor 144, a tension sensor 146 and a position sensor 148, and is configured to receive input data indicative of a selected disengage load, a selected disengage number of rotations per minute, a selected disengage tensile load and/or a selected disengage distance.

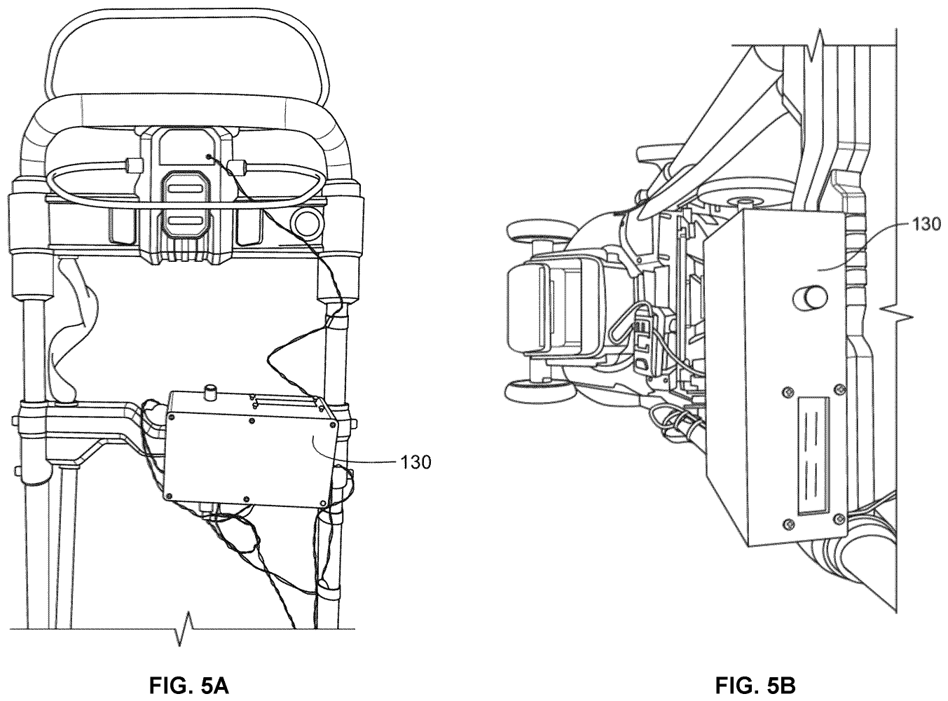

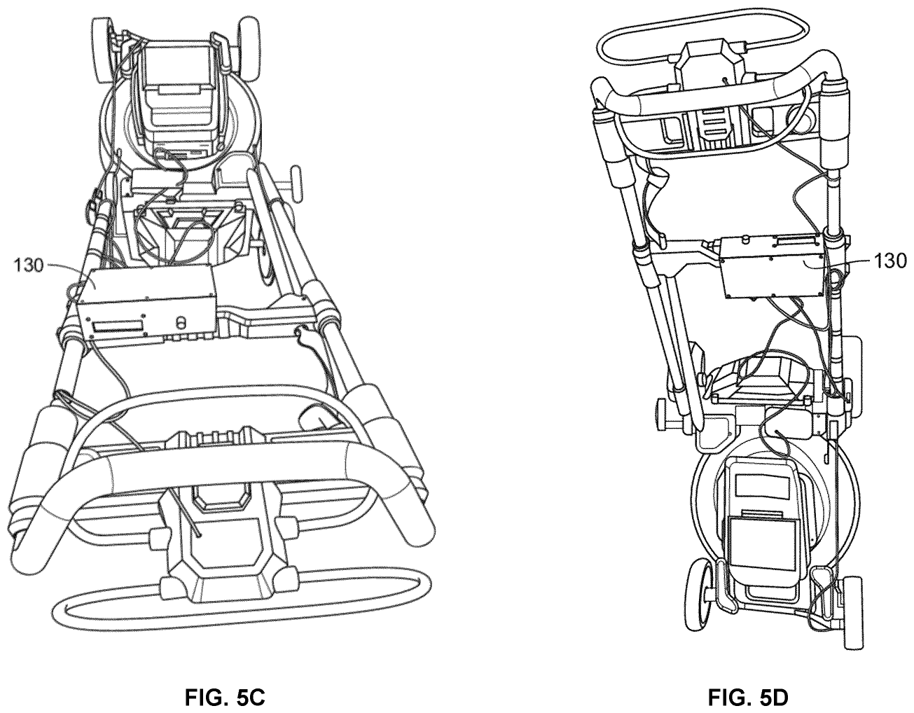

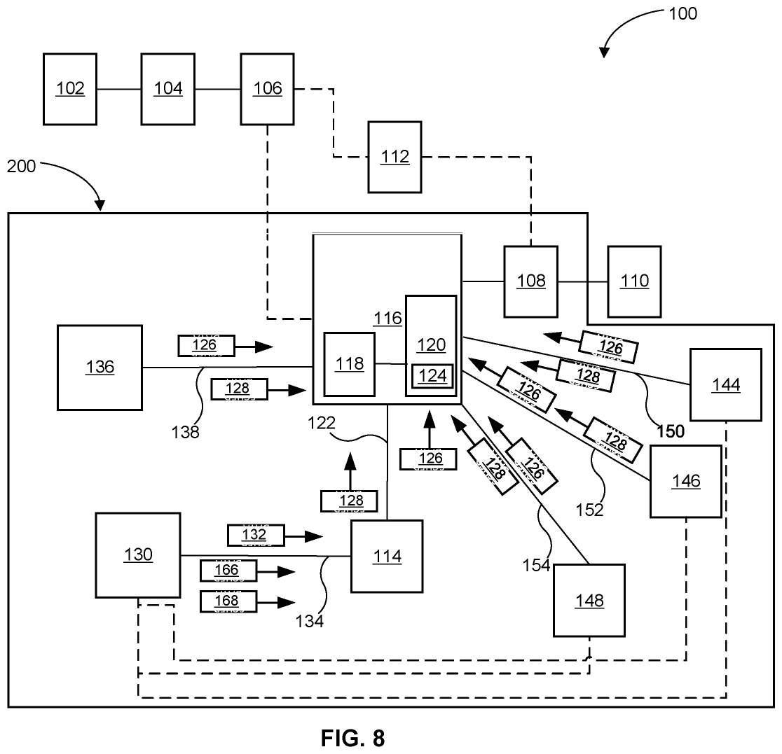

Attention is directed to FIG. 8, depicting a schematic of an autosensing module for a lawn mower, according to non-limiting embodiments, example autosensing module 200. In the example autosensing module 200, in which like or similar elements are denoted by like or similar numbers in FIGS. 1 to 7. For simplicity and eas of understanding, discussion of autosensing module 200 depicted in FIG. 8 will focus on certain similarities and differences from those depicted in FIGS. 1 to 7.

As shown in FIG. 8, example autosensing module 200 comprises a drive motor configured to operatively connect to a wheel assembly of a lawn mower, such as drive motor 108, and one or more of: a tilt sensor configured to sense a tilt angle of the lawn mower relative to a direction of travel along a cutting surface (such as tilt sensor 114), a wheel rotation sensor configured to sense rotation of at least one wheel of the wheel assembly (such as wheel rotation sensor 136), a wheel load sensor configured to sense a load applied to at least one wheel of the lawn mower via the cutting surface (such as wheel load sensor 144), a tension sensor operatively connected to at least one wheel tension rod (such as tension sensor 146), and a position sensor configured to sense a position of the lawn mower relative to the cutting surface (such as position sensor 148). Autosensing module 200 further comprises a controller operatively connected to the drive motor (such as controller 116) and configured to disengage the drive motor in response to receiving a disengage signal (such as disengage signal 126), without disengaging a motor operatively connected to at least one blade of the lawn mower (such as motor 106). According to some embodiments, the tilt sensor, the wheel rotation sensor, the wheel load sensor, the tension sensor and the position sensor are in communication with the controller and configured to generate and transmit the disengage signal for receipt by the controller when the tilt angle sensed by the tilt sensor is at or above a disengage angle, or the sensed rotation is at or below a disengage number of rotations per minute (RPM), or the sensed load is at or below a disengage load, or the sensed tensile load is at or below a disengage tensile load, or the sensed position is at or above a disengage distance away from the cutting surface. According to some embodiments, the autosensing module is provided for installation on a lawn mower (for example, as an after-market item, which may be sold as a kit). According to some embodiments, the autosensing module is provided pre-installed on a lawn mower.

Persons skilled in the art will appreciate that there are yet more alternative implementations and modifications possible, and that the above examples are only illustrations of one or more implementations. The scope, therefore, is only to be limited by the claims appended hereto.

### INTERPRETATION

It will also be understood that for the purposes of this application, “at least one of X, Y, and Z” or “one or more of X, Y, and Z” language can be construed as X only, Y only, Z only, or any combination of two or more items X, Y, and Z (e.g., XYZ, XYY, YZ, ZZ).

In the present application, components may be described as being “configured to” or “enabled to” perform one or more functions. Generally, it is understood that a component that is configured to or enabled to perform a function is configured to or enabled to perform the function, or is suitable for performing the function, or is adapted to perform the function, or is operable to perform the function, or is otherwise capable of performing the function.

Additionally, components in the present application may be described as being “operatively connected to”, “operatively coupled to”, and the like, to other components. It is understood that such components are connected or coupled to each other in a manner to perform a certain function. It is also understood that “connections”, “coupling” and the like, as recited in the present application include direct and indirect connections between components.

It is understood that for the purpose of this specification, references to a “signal” or “signals” are, unless otherwise specified, also references to data that may be embedded in said “signal” or “signals”.

It is understood that any reference to a “communication link” or “communication links” refers to any suitable wired and/or wireless communication link(s), or suitable combination thereof, and configured to operated in accordance with any suitable wired and/or wireless protocols.

References in the application to “one embodiment”, “an embodiment”, “an implementation”, “a variant”, etc., indicate that the embodiment, implementation or variant described may include a particular aspect, feature, structure, or characteristic, but not every embodiment, implementation or variant necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely”, “only”, and the like, in connection with the recitation of claim elements or use of a “negative” limitation. The terms “preferably”, “preferred”, “prefer”, “optionally”, “may”, and similar terms are used to indicate that an item, condition or step being referred to is an optional (not required) feature of the invention.

The singular forms “a”, “an”, and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of +5%, +10%, +20%, or +25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A lawn mower comprising:
at least one cutting blade;
a blade motor operatively connected to the at least one cutting blade via a blade drive assembly;
a drive motor operatively connected to a wheel assembly of the lawn mower;
a tilt sensor configured to sense a tilt angle of the lawn mower relative to a direction of travel along a cutting surface; and
a controller operatively connected to the drive motor and in communication with the tilt sensor, the controller configured to disengage the drive motor in response to receiving a disengage signal, without disengaging the blade motor;
wherein when the tilt sensor senses the tilt angle is at or above a disengage angle, the tilt sensor transmits the disengage signal for receipt by the controller.

2. The lawn mower of claim 1, wherein the controller is further configured to engage the drive motor in response to receiving an engage signal.

3. The lawn mower of claim 2, wherein when the tilt sensor senses that the tilt angle is at an engage angle less than the disengage angle relative to the direction of travel along the cutting surface, the tilt sensor transmits the engage signal for receipt by the controller.

4. The lawn mower of claim 2 further comprising:
a wheel rotation sensor in communication with the controller and configured to sense rotation of at least one wheel of the wheel assembly, wherein when the sensed rotation is at or below a disengage number of rotations per minute (RPM), the wheel rotation sensor transmits the disengage signal for receipt by the controller.

5. The lawn mower of claim 4, wherein when the sensed rotation is at or above an engage number of rotations per minute (RPM), the wheel rotation sensor is configured to transmit the engage signal for receipt by the controller.

6. The lawn mower of claim 1 further comprising one or more of:
a wheel load sensor configured to sense a load applied to at least one wheel of the lawn mower via the cutting surface, the wheel load sensor being in communication with the controller and configured to transmit the disengage signal for receipt by the controller when the sensed load is at or below a disengage load;
a tension sensor operatively connected to at least one wheel tension rod and in communication with the controller, the tension sensor configured to sense a tensile load on the at least one wheel tension rod and to transmit the disengage signal for receipt by the controller when the sensed tensile load is at or below a disengage tensile load; and
a position sensor configured to sense a position of the lawn mower relative to the cutting surface, the position sensor being in communication with the controller and configured to transmit the disengage signal when the sensed position is at or above a disengage distance away from the cutting surface.

7. The lawn mower of claim 1, wherein the tilt sensor comprises one or more of an accelerometer, an inclinometer and a gyroscope.

8. The lawn mower of claim 1, wherein the disengage angle is in a range of about 1 degree to about 90 degrees, or about 30 degrees to about 45 degrees.

9. The lawn mower of claim 1 further comprising:
an input device in communication with the tilt sensor and configured to receive input data indicative of a selected disengage angle and to transmit the received input data to the tilt sensor, wherein the disengage angle is the selected disengage angle.

10. A lawn mower comprising:
at least one cutting blade;
a blade motor operatively connected to the at least one cutting blade via a blade drive assembly;
a drive motor operatively connected to a wheel assembly of the lawn mower;
a wheel rotation sensor configured to sense rotation of at least one wheel of the wheel assembly; and
a controller operatively connected to the drive motor and in communication with the wheel rotation sensor, the controller configured to disengage the drive motor in response to receiving a disengage signal without disengaging the blade motor;
wherein when the sensed rotation is at or below a disengage number of rotations per minute (RPM), the wheel rotation sensor transmits the disengage signal for receipt by the controller.

11. The lawn mower of claim 10, wherein the controller is further configured to engage the drive motor in response to receiving an engage signal.

12. The lawn mower of claim 11, wherein the wheel rotation sensor is configured to transmit the engage signal for receipt by the controller when the sensed rotation is at or above an engage number of rotations per minute (RPM).

13. The lawn mower of claim 10 further comprising:
an input device in communication with the wheel rotation sensor and configured:
receive input data indicative of a selected disengage number of rotations per minute and to transmit the received input data to the wheel rotation sensor, wherein the disengage number of rotations per minute is the selected disengage number of rotations; and/or
receive input data indicative of a selected engage number of rotations per minute and to transmit the received input data to the wheel rotation sensor, wherein the engage number of rotations per minute is the selected engage number of rotations per minute.

14. The lawn mower of claim 10 further comprising:
a tilt sensor in communication with the controller and configured to sense a tilt angle of the lawn mower relative to a direction of travel along a cutting surface;
wherein when the tilt sensor senses the tilt angle is at or above a disengage angle, the tilt sensor transmits the disengage signal for receipt by the controller.

15. The lawn mower of claim 14, wherein the tilt sensor comprises one or more of an accelerometer, an inclinometer and a gyroscope.

16. The lawn mower of claim 14, wherein the disengage angle is in a range of about 1 degree to about 90 degrees, or about 30 degrees to about 45 degrees.

17. The lawn mower of claim 14 wherein the input device is further configured to receive input data indicative of a selected disengage angle and to transmit the received input data to the tilt sensor, wherein the disengage angle is the selected disengage angle.

18. The lawn mower of claim 14, wherein when the tilt sensor senses that the tilt angle is at an engage angle less than the disengage angle relative to the direction of travel along the cutting surface, the tilt sensor transmits the engage signal for receipt by the controller.

19. The lawn mower of claim 10 further comprising one or more of:
a wheel load sensor configured to sense a load applied to at least one wheel of the lawn mower via the cutting surface, the wheel load sensor being in communication with the controller and configured to transmit the disengage signal for receipt by the controller when the sensed load is at or below a disengage load;
a tension sensor operatively connected to at least one wheel tension rod and in communication with the controller, the tension sensor configured to sense a tensile load on the at least one wheel tension rod and to transmit the disengage signal for receipt by the controller when the sensed tensile load is at or below a disengage tensile load; and
a position sensor configured to sense a position of the lawn mower relative to the cutting surface, the position sensor being in communication with the controller and configured to transmit the disengage signal when the sensed position is at or above a disengage distance away from the cutting surface.

20. A lawn mower comprising:
at least one cutting blade;
a blade motor operatively connected to the at least one cutting blade via a blade drive assembly;
a drive motor operatively connected to a wheel assembly of the lawn mower;
a position sensor configured to sense a position of the lawn mower relative to the cutting surface; and
a controller operatively connected to the drive motor and in communication with the tilt sensor, the controller configured to disengage the drive motor in response to receiving a disengage signal, without disengaging the blade motor;
wherein when the position sensor being in communication with the controller and configured to transmit the disengage signal when the sensed position is at or above a disengage distance away from the cutting surface.

21. (canceled)

22. (canceled)
